(19) United States
(12) Patent Application Publication
(10) Pub. No.: US 2025/0149283 A1
(43) Pub. Date: May 8, 2025

(54) ARC GAS DISCHARGE DEVICE OF AIR CIRCUIT BREAKER

(71) Applicant: LS ELECTRIC CO., LTD., Anyang-si, Gyeonggi-do (KR)

(72) Inventor: Seung Pil YANG, Anyang-si, Gyeonggi-do (KR)

(21) Appl. No.: 18/837,661

(22) PCT Filed: Feb. 2, 2023
(86) PCT No.: PCT/KR2023/001533

§ 371 Date: Aug. 12, 2024

(30) Foreign Application Priority Data
Mar. 8, 2022 (KR) 10-2022-0029078

(51) Int. Cl. H01H 73/18; H01H 9/34; H01H 33/08

(52) U.S. Cl. CPC H01H 73/18; H01H 9/342; H01H 33/08

(57) ABSTRACT

Disclosed is an arc gas discharge device of an air circuit breaker, capable of preventing damage to an arc extinguishing chamber caused by a sudden rise in pressure. The arc gas discharge device of an air circuit breaker, according to one embodiment of the present disclosure, comprises: a base having an arc extinguishing space in which an arc, generated by means of the operation of a movable contact with respect to a stationary contact, rises and is extinguished; an arc extinguishing unit which is provided in the arc extinguishing space of the base, and which has a the plurality of gridss so that the arc is extinguished and is exhausted through the top thereof; a guide member which is provided in the base and has a part thereof that restricts and guides the arc extinguishing unit so that the arc extinguishing unit can be slightly elevated in the arc extinguishing space; and an elastic member for providing elastic force so that the arc extinguishing unit comes in close contact with the base in the arc extinguishing space, wherein, if an arc gas exceeds a certain pressure, the extinguishing unit rises while overcoming the elastic force of the elastic member, and an exhaust passage is open between the arc extinguishing unit and the base so that the arc gas can be exhausted.

### CROSS-REFERENCE TO RELATED APPLICATIONS

This application is the National Stage filing under 35 U.S.C. 371 of International Application No. PCT/KR2023/001533, filed on Feb. 2, 2023, which claims the benefit of earlier filing date and right of priority to Korean Application No. 10-2022-0029078, filed on Mar. 8, 2022, the contents of which are all hereby incorporated by reference herein in their entirety.

### FIELD

The present disclosure relates to an arc gas discharge device of an air circuit breaker, and more specifically, to an arc gas discharge device of an air circuit breaker capable of preventing damage to an arc extinguishing chamber due to a sudden rise in pressure.

### BACKGROUND

In general, conventional circuit breakers turn on or off devices for receiving power through power transmission and transformation systems or power lines and protect electric power systems and load devices by blocking current when accidents such as overload and short circuits occur.

Such a conventional circuit breaker includes a movable contact and a stationary contact configured to come into contact with the movable contact. When the movable contact comes into contact with the stationary contact, a current flows through a power line, and when a high current flows through the power line due to an accident, the movable contact is separated from the stationary contact to block the current of the power line.

With recent increases in electric capacity of an electric power system, a high current now needs to flow through a circuit breaker.

The conventional air circuit breaker extinguishes an arc, which is generated when blocking an overcurrent/short circuit accident, by dividing the arc using a grid in an arc chamber. A blocking process of a direct current (DC) air circuit breaker is harder than that of an alternating current (AC) circuit breaker, and since there is no zero current in a DC in contrast to an AC property that there is a zero current once at every half cycle, the DC air circuit breaker should raise an arc voltage by dividing the arc into smaller pieces. Accordingly, more metal grids should be disposed, and gaps become narrower.

When the conventional air circuit breaker blocks electricity, an arc and a gas are generated. Since the gas generated at this time raises an internal pressure of an arc extinguishing chamber to push the arc and the gas generated during the blocking toward an arc chute pushes, the gas acts to be advantageous for extinguishing the arc. However, an excessive pressure acts to be disadvantageous for blocking by causing a backflow of the gas. Particularly, there is a problem that excessive mechanical strength of an instrument is inevitably provided to prevent damage to the fire extinguishing chamber due to the excessive pressure.

### SUMMARY

The present disclosure is directed to solving the problems and providing an arc gas discharge device of an air circuit breaker to which a structure capable of pushing an arc chute upward when an internal pressure in an extinguishing chamber rises to a specific value or more is applied to maintain a pressure in an arc extinguishing chamber by discharging an overpressure gas.

Objectives of the present disclosure are not limited to the above-described objectives, and other objectives which are not described may be clearly understood by those skilled in the art from the following descriptions.

### Technical Solution

One aspect of the present invention provides an arc gas discharge device of an air circuit breaker, including a base in which an arc extinguishing space, in which an arc generated by operation of a movable contact with respect to a stationary contact is extinguished, is formed, an arc extinguishing unit which is installed in the arc extinguishing space of the base, includes a plurality of grids, extinguishes the arc, and discharges an arc gas upward, a guide member which is installed on the base and guides the arc extinguishing unit while a portion of the arc extinguishing unit is restricted to slightly move the arc extinguishing unit upward or downward in the arc extinguishing space, and an elastic member which provides an elastic force such that the arc extinguishing unit is in close contact with the base in the arc extinguishing space, wherein, when a pressure of the arc gas is a predetermined pressure or more, the arc extinguishing unit overcomes the elastic force of the elastic member and moves upward, and an exhaust passage is opened between the arc extinguishing unit and the base to discharge the arc gas.

In this case, the guide member may be a guide bolt which passes through a through portion formed in the arc extinguishing unit and is fixed to the base.

In this case, a cross-shaped groove may be formed in the base, a nut may be inserted into the cross-shaped groove not to be vertically come out, and the guide bolt may be fastened to the nut.

In this case, the arc gas discharge device may include a cap which is inserted into the cross-shaped groove after the nut is inserted into the cross-shaped groove such that the nut is disposed at a fastening location.

In this case, the elastic member may be a spring installed between a head of the guide bolt and the arc extinguishing unit.

In this case, the head of the guide bolt may be formed in a dish shape, and a tapered portion corresponding to the dish shape may be formed in the through portion of the arc extinguishing unit.

In this case, the through portion of the arc extinguishing unit may be formed in a cylindrical shape such that the elastic member is installed on an outer surface of the through bolt.

In this case, a seating groove may be formed in the base such that a flange part of the arc extinguishing unit is seated in the seating groove, cut surfaces may be formed on an inner side of the seating groove and an inner side of the flange part, and when the arc extinguishing unit moves upward, portions of the cut surfaces may overlap to form an exhaust passage.

In this case, a vertical surface of the flange part and a vertical surface of the seating groove may be spaced apart from each other and communicate with the exhaust passage.

In this case, the flange part and the seating groove may be disposed in close contact with each other, and the cut surfaces may be formed by cutting a corner of a lower end portion of the flange part and a corner of an upper end portion of the seating groove in a chamfering manner.

According to the above-described configuration, an air circuit breaker according to the present disclosure can prevent damage to an arc extinguishing unit by quickly discharging some of an arc gas when a sudden rise in pressure of the arc gas occurs.

In addition, since the air circuit breaker according to the present disclosure can restrict a rising pressure of the arc gas to a predetermined pressure or less, there is no need to excessively set a mechanical strength of an instrument to prevent damage to an arc extinguishing chamber.

Effects of the present disclosure are not limited to the above-described effects and should be understood to include all effects which may be inferred from configurations of the present disclosure described in the detailed description and the claims of the present disclosure.

### BRIEF DESCRIPTION OF THE DRAWINGS

FIG. 1 is a perspective view illustrating an air circuit breaker according to one embodiment of the present disclosure.

FIG. 2 is a partially exploded perspective view illustrating the air circuit breaker according to one embodiment of the present disclosure.

FIGS. 3 and 4 are perspective views illustrating an arc extinguishing unit of the air circuit breaker according to one embodiment of the present disclosure.

FIGS. 5 and 6 are exploded perspective views illustrating the arc extinguishing unit of the air circuit breaker according to one embodiment of the present disclosure.

FIG. 7A is an enlarged view illustrating a rear base and some portions which are some components of the air circuit breaker according to one embodiment of the present disclosure, and FIG. 7B is a partial cutaway view illustrating an enlarged portion of FIG. 7A.

FIG. 8 is a cross-sectional view illustrating the air circuit breaker according to one embodiment of the present disclosure.

FIG. 9 is an enlarged view illustrating portion A illustrated in FIG. 8.

FIGS. 10A and 10B are cross-sectional views illustrating an arc gas discharge device of the air circuit breaker according to one embodiment of the present disclosure when the arc gas discharge device operates, wherein FIG. 10A shows the arc gas discharge device before operating, and FIG. 10B shows the arc gas discharge device after operating.

### DETAILED DESCRIPTION

Hereinafter, embodiments of the present disclosure will be described in detail with reference to the accompanying drawings in order for those skilled in the art to easily perform the present disclosure. The present disclosure may be implemented in several different forms and is not limited to the embodiments described herein. Portions irrelevant to description are omitted in the drawings in order to clearly describe the present disclosure, and the same or similar components are denoted by the same reference numerals throughout the specification.

Terminologies and words used in the present specification and claims should not be interpreted as limited to commonly used meanings or meanings in dictionaries and should be interpreted with meanings and concepts which are consistent with the technological scope of the present disclosure based on the principle that the inventors have appropriately defined concepts of terminologies in order to describe the disclosure in the best way.

Therefore, since the embodiments described in the present specification and configurations illustrated in the drawings are only exemplary embodiments and do not represent the overall technological scope of the disclosure, the corresponding configurations may have various equivalents and modifications that can substitute for the configurations at the time of filing of the present disclosure.

It should be understood that the terms “comprise,” “include,” and the like herein specify the presence of stated features, numbers, operations, elements, components, or groups thereof but do not preclude the presence or addition of one or more other features, numbers, operations, elements, components, or groups thereof.

Unless there are special circumstances, a case in which a first component is disposed “in front of,” “behind,” “above,” or “below” a second component includes not only a case in which the first component is disposed directly “in front of,” “behind,” “above,” or “below” the second component, but also a case in which a third component is interposed therebetween. Unless there are special circumstances, a case in which a first component is connected to a second component includes not only a case in which the first component is directly connected to the second component, but also a case in which the first component is indirectly connected to the second component.

Hereinafter, an arc gas discharge device of an air circuit breaker 1 according to one embodiment of the present disclosure will be described with reference to the accompanying drawings.

An arc gas discharge device of the air circuit breaker 1 according to one embodiment of the present disclosure may include bases 3 and 4, arc extinguishing units 20, guide members, and elastic members.

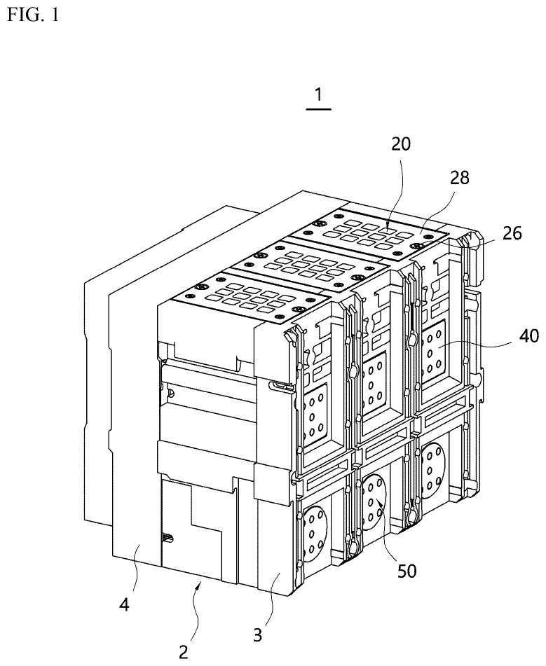

Referring to FIGS. 1, 2, and 7, an arc extinguishing space 20a, in which an arc generated when a movable contact operates with respect to a stationary contact is extinguished, may be formed between the bases 3 and 4.

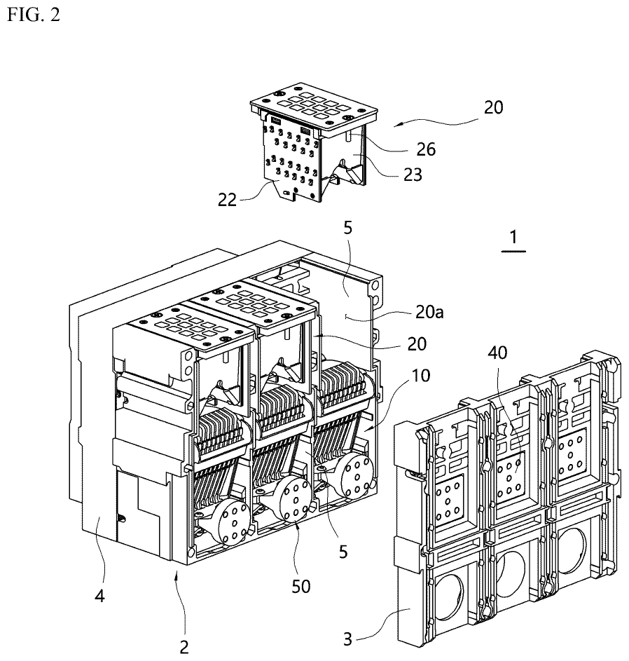

In this case, referring to FIG. 2, the bases 3 and 4 may include a front base 4 and a rear base 3, and a main body 2 including an operation part 10 in which the stationary contact and the movable contact operate to generate an arc is installed between the front base 4 and the rear base 3. The arc extinguishing space 20a is located on the operation part 10 of the main body 2. That is, it is designed such that a space in which an arc is extinguished before an arc gas is discharged to the outside is located and the gas of which the arc is extinguished is discharged. Operation parts 10 and arc extinguishing spaces 20a are installed to be divided into a plurality thereof by partition walls 5. The operation parts 10 may be individually controlled.

Referring to FIGS. 2 to 6, and 8, the arc extinguishing unit 20 may be installed in the arc extinguishing space 20a between the bases 3 and 4 and include a plurality of grids 23 such that an arc is extinguished between the grids 23, and an arc gas may be exhausted upward.

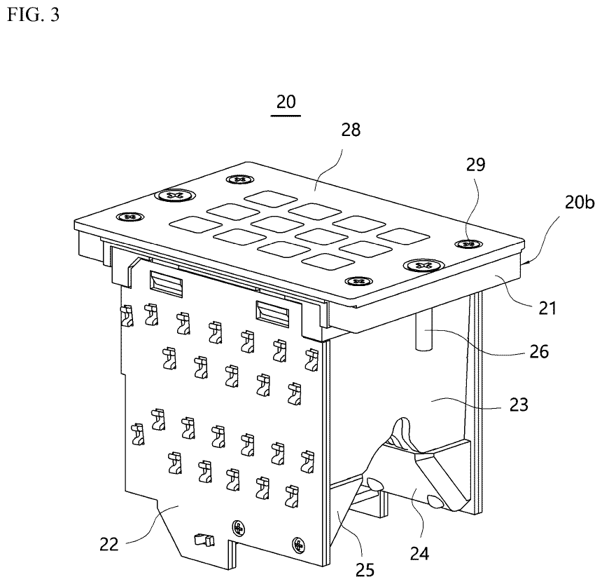

In this case, referring to FIGS. 3 to 6, the arc extinguishing unit 20 is formed in a substantially rectangular hexahedron shape, and an arc is introduced from under the arc extinguishing unit 20 and is extinguished between the grids 23. Then, the arc passes through filters above the grids 23 and a discharge port 28a of an upper cover member 28 to be discharged.

In this case, the arc extinguishing unit 20 includes a frame 21 having a quadrangular frame shape, and side panels 22 are fixedly assembled with both lower side surfaces of the frame 21. An arc runner 25 may be assembled with a lower front surface of the frame 21 to guide an arc with an arc guide 24 under the frame 21. The plurality of grids 23 are assembled with a lower portion of the frame 21 to be supported by the side panels 22. A sealing member 27 is disposed on the frame 21, and the upper cover member 28 is fixedly fastened to the frame 21 by the fastening member 29 on the sealing member 27. Accordingly, an arc generated by the operation part 10 may be induced between the plurality of grids 23 by the arc guide 24, be extinguished while passing through the plurality of grids 23, pass through the filters, and be discharged through the discharge port 28a of the upper cover member 28.

Referring to FIGS. 3 to FIG. 10B, the guide members may be installed between the bases 3 and 4 and guide the arc extinguishing unit while a portion of the arc extinguishing unit 20 is restricted to slightly move the arc extinguishing unit 20 upward or downward in the arc extinguishing space 20a.

In this case, the guide members may be guide bolts 26 which pass through portions 28b formed in the arc extinguishing unit 20 and fixed to the bases 3 and 4. Heads of the guide bolts 26 are hooked on upper portions of the through portions 28b, and springs 26a which are the elastic members are embedded in the through portions 28b.

In this case, cross-shaped grooves 3a are formed in the bases 3 and 4, nuts 26b are inserted into the cross-shaped grooves 3a so as not to be vertically come out, and the guide bolts 26 may be fastened to the nuts 26b. The nuts 26b are inserted into horizontal portions of the cross-shaped grooves 3a, and the guide bolts 26 pass through the vertical portions and are fastened to the nuts 26b. Accordingly, since the guide bolt 26 is fixed to the base 3 by the nut 26b, and the guide bolt 26 only passes through the through portion 28b of the arc extinguishing unit 20 without being fastened thereto, the arc extinguishing unit 20 may be guided to vertically move upward or downward.

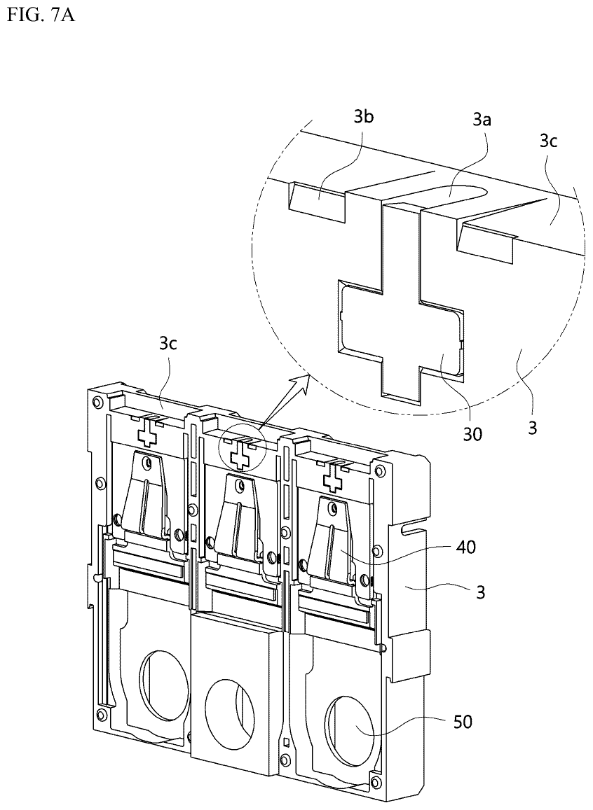

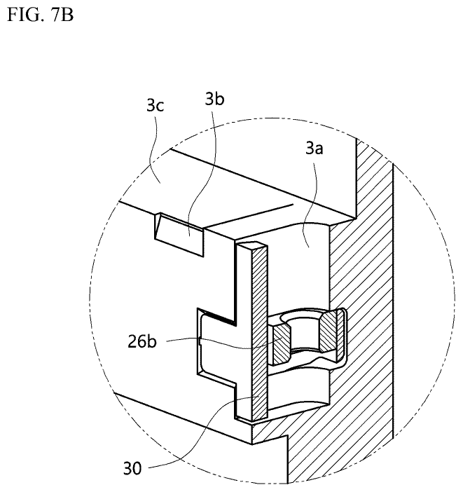

In this case, referring to FIGS. 7A and 7B, a cap 30 inserted into the cross-shaped groove 3a after the nut 26b is inserted such that the nut 26b is disposed at a fastening location may be included. The cap 30 is provided such that the nut is located at a correct location at which the guide bolt 26 is fastened to the nut 26b. A seating groove in which the nut 26b is seated is formed in the cap 30, and when the nut 26b is fitted into the groove and the cap 30 is inserted into the cross-shaped groove 3a, the nut 26b is correctly located at the fastening location. In FIG. 7B, a longitudinal cross-section of the cap 30 is illustrated to show the inside of the cap 30 in a state in which the cap 30 is inserted. The cap 30 may be inserted into the cross-shaped groove 3a in a state in which the nut 26b is inserted thereinto.

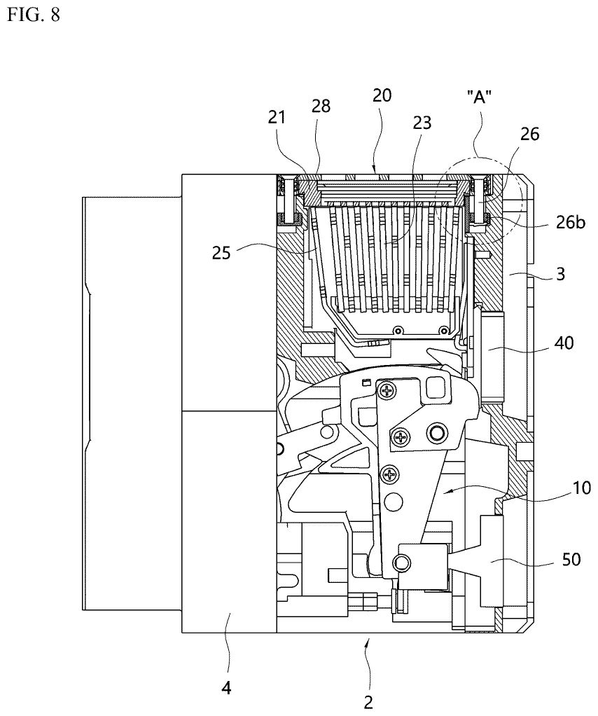

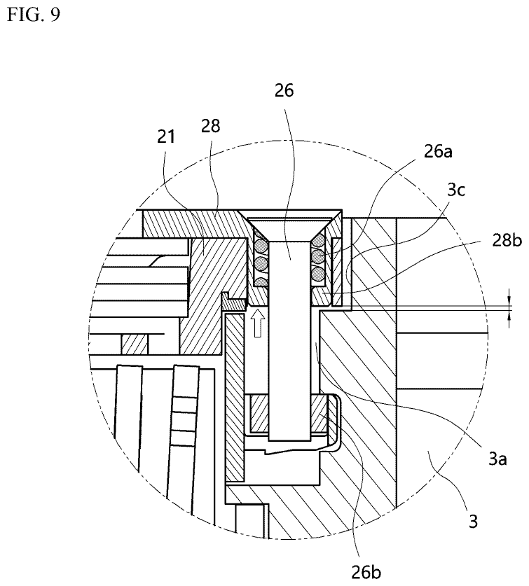

In this case, referring to FIG. 9, the head of the guide bolt 26 may be formed in a dish shape, and a tapered portion corresponding to the dish shape may be formed in the through portion 28b of the arc extinguishing unit 20.

In this case, the through portion 28b of the arc extinguishing unit 20 may be formed in a cylindrical shape such that the elastic member is installed on an outer surface of the through bolt 26. As the cylindrical shape is formed, the spring 26a which is the elastic member may be embedded in the outer surface of the guide bolt 26.

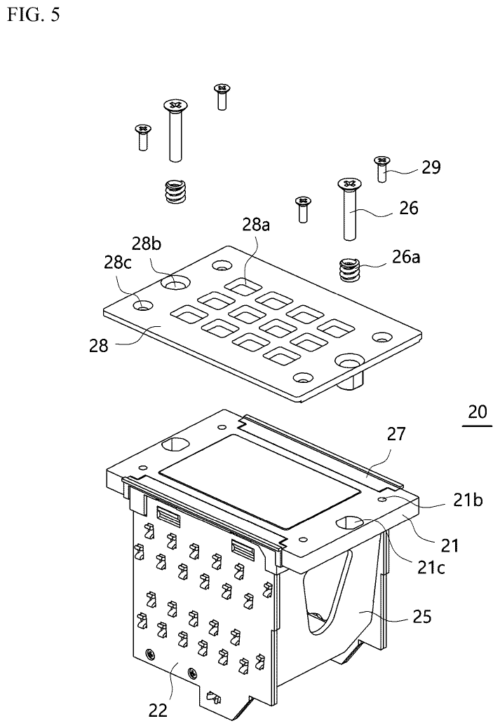

Referring to FIGS. 5 to 7B and 9, the elastic member may provide an elastic force such that the arc extinguishing unit 20 is in close contact with the bases 3 and 4 in the arc extinguishing space 20a. Accordingly, when a pressure of the arc gas is a predetermined pressure or more, the arc gas overcomes the elastic force of the elastic member, and thus the arc extinguishing unit 20 may be moved upward, an exhaust passage may be opened between the arc extinguishing unit 20, and the bases 3 and 4, and the arc gas may be discharged.

In this case, the elastic member may be the spring 26a installed between the head of the guide bolt 26 and the arc extinguishing unit 20. A lower end of the spring 26a is caught on the through portion 28b, and an upper end is pressed by the head of the guide bolt 26.

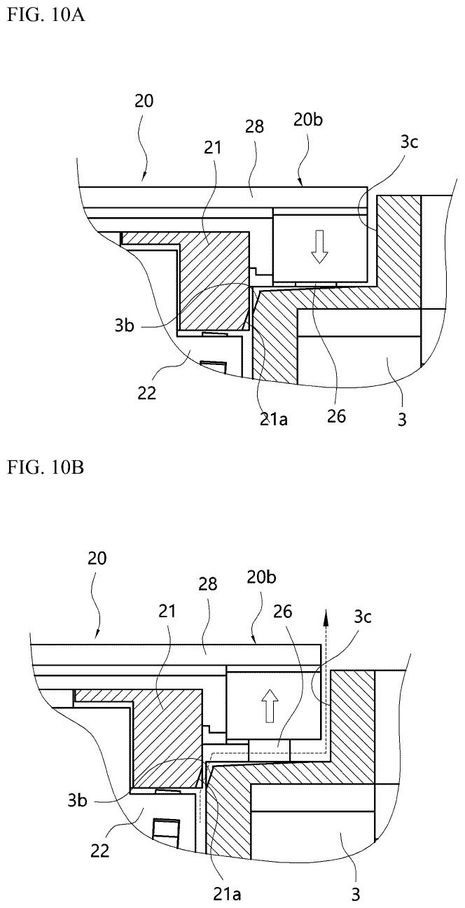

In this case, referring to FIGS. 9, 10A, and 10B, seating grooves 3c may be formed in the bases 3 and 4 such that flange parts 20b of the arc extinguishing unit 20 are seated in the seating grooves 3c, cut surfaces 3b and 21a which are cut portions may be formed on inner sides of the seating grooves 3c and inner sides of the flange parts 20b, and when the arc extinguishing unit 20 moves upward, the cut surfaces 3b and 21a partially overlap to constitute the exhaust passage. Portions of the frame 21 and the upper cover member 28 may constitute the flange part 20b.

In this case, referring to FIGS. 9, 10A, and 10B, a vertical surface of the flange part 20b and a vertical surface of the seating groove 3c may be spaced apart from each other and communicate with the exhaust passage.

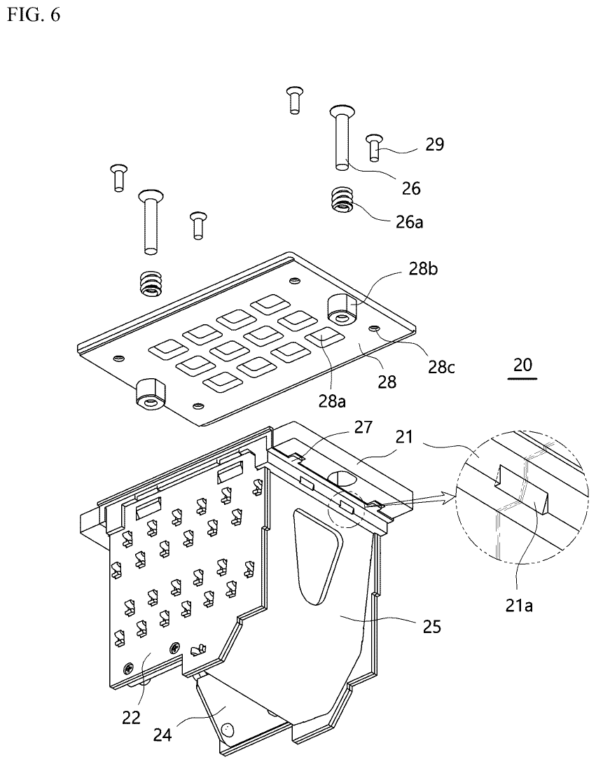

In this case, referring to FIGS. 10A and 10B, the flange part 21 and the seating groove 3c may be disposed in close contact with each other, and the cut surfaces 3b and 21a may be formed by cutting a corner of a lower end portion of the flange part 21 and a corner of an upper end portion of the seating groove 3c in a chamfering manner. Although one of each of the cut surfaces 3b and 21a is illustrated in the cross-sectional view, referring to FIG. 7A, each of the cut surfaces 3b and 21a may be formed as a plurality thereof with different lengths. In this case, since the cut surfaces 3b and 21a are formed by cutting the corner portions of the seating grooves 3c and the flange part 21 in the chamfering manner, cutting angles and shapes may be variously changed. In addition, referring to FIG. 6, although the cut surface 21a formed in the flange part 21 has a shape in which a portion is simply cut at a predetermined angle, referring to FIGS. 7A and 10B, the cut surface 3b formed in the seating groove 3c may have a shape having a double-cut surface. That is, the cut surface 3b formed in the seating groove 3c may be formed to have two different inclinations.

Referring to FIG. 1, a perspective view of the air circuit breaker 1 according to one embodiment of the present disclosure is illustrated. The bases 3 and 4 are located at front and rear sides, and the main body 2 is located between the front base 4 and the rear base 3. The operation part 10, an upper fixing terminal 40, and a lower fixing terminal 50 are located in a lower portion of the main body 2. The arc extinguishing unit 20 is installed in an upper portion of the main body 2. Each of the operation part 10 and the arc extinguishing unit 20 is installed as a plurality thereof divided by the partition walls 5.

Referring to FIG. 2, a partially exploded perspective view of the air circuit breaker 1 according to one embodiment of the present disclosure is illustrated. The main body 2 is located between the front base 4 and the rear base 3, and the plurality of operation parts 10 and the plurality of arc extinguishing units 20 are formed. The arc extinguishing space 20a is formed on each of the operation parts 10, and an arc generated by the operation part 10 may move to the arc extinguishing unit 20 installed in the arc extinguishing space 20a due to a pressure thereof. The plurality of operation parts 10 are divided by the partition walls 5. In this case, the arc extinguishing unit 20 is installed to be slightly moved upward or downward with respect to the front base 4 and the rear base 3. That is, when a pressure of an arc gas introduced into the arc extinguishing unit 20 is a predetermined pressure or more, the arc extinguishing unit 20 may be slightly moved upward, the exhaust passage may be formed between the arc extinguishing unit 20 and the bases 3 and 4, and some of the arc gas may be discharged to prevent damage to the arc extinguishing unit 20. In the single arc extinguishing unit 20, front and rear sides of the arc extinguishing unit 20 are assembled with the bases 3 and 4 using the guide bolts 26, and left and right sides are assembled with upper ends of the partition walls 5 to be sealed by the sealing member 27. However, the exhaust passage may be formed between the bases 3 and 4 and the arc extinguishing unit 20 to discharge an overpressure arc gas.

Referring to FIGS. 3 to 6, perspective and exploded perspective views of the arc extinguishing unit 20 of the air circuit breaker 1 according to one embodiment of the present disclosure are illustrated. The arc extinguishing unit 20 includes the frame 21 having the quadrangular frame shape. The side panels 22 are fixed to both sides of the frame 21, and nut holes 21b are formed in both sides of the frame 21 such that the upper cover member 28 is assembled with the frame 21. In addition, through holes 21c through which through ports 28b of the upper cover member 28 pass are formed in the frame 21. The upper cover member 28 is assembled with the frame 21 in a state in which the sealing member 27 is disposed on the frame 21. The guide runner 25 and the arc guide 24 are installed under the frame 21, and the plurality of grids 23 are assembled with the lower portion of the frame 21 using the side panels 22. An arc generated by the operation part 10 may be introduced between the grids 23 and extinguished, and pass through the filter and the discharge port 28a of the upper cover member 28 to be discharged.

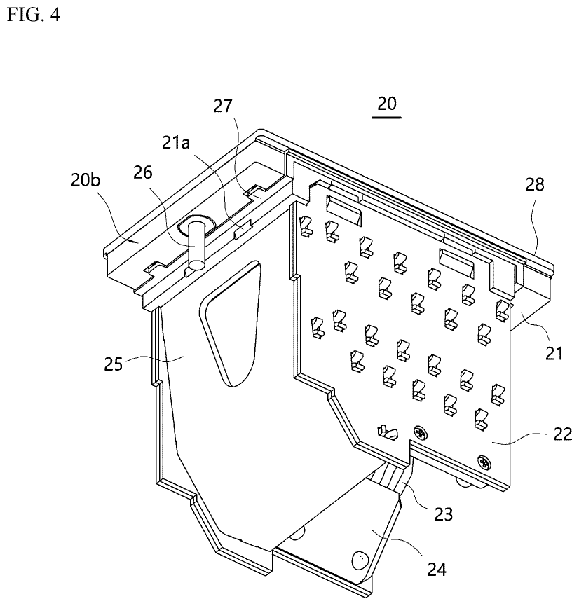

Referring to FIGS. 4 and 6, in the flange part 20b of the arc extinguishing unit 20 in close contact with the bases 3 and 4, the through portion 28b may be formed on an upper cover member 28, and the spring 26a and the guide bolt 26 may be assembled with the through portion 28b. After the spring 26a is inserted into the through portion 28, the guide bolt 26 is inserted thereinto and assembled with the base 3 or 4 with the frame 21 using the nut 26b. Accordingly, the guide bolt 26 is in a state of being fixed to the base 3 or 4, and upward or downward movement of the arc extinguishing unit 20 is guided by the guide bolt 26. In this case, the assembly is performed in a state in which with an elastic force is always provided such that the flange part 20b of the arc extinguishing unit 20 is in close contact with the seating grooves 3c due to an elastic force of the spring 26a. In addition, since the cut portion 21a is formed in the frame 21 constituting the flange part 20b of the arc extinguishing unit 20, and the cut portion 21a of the frame 21 is positioned at a level overlapping the cut portion 3b formed in the seating groove 3c of the base 3 when the arc extinguishing unit 20 is moved upward by an overpressure of an arc gas, some of the arc gas passes between the cut portions 3b and 21a. The cut portions 3b and 21a may be formed at specific locations, and widths and the number thereof may be changed according to design.

Referring to FIGS. 7A and 7B, an enlarged view illustrating the rear base 3 and some portions which are some components of the air circuit breaker 1 according to one embodiment of the present disclosure is illustrated. The seating groove 3c is formed in an upper end portion of the rear base 3, and the cross-shaped groove 3a is formed inside the seating groove 3c. The nut 26b may be assembled with the cross-shaped groove 3 to be located at a correct location using the cap 30. In addition, the cut portion 3b is formed in the seating groove 3c to form a portion of the exhaust passage in conjunction with the cut portion 21a of the arc extinguishing unit 20. Normally, the cut portions 3b of the bases 3 and 4 are positioned at levels higher than that of the cut portion 21a of the arc extinguishing unit 20, and when the arc extinguishing unit 20 moves upward, the cut portions 3b and 21a overlap, and thus the exhaust passage is formed between the cut portions 3b and 21a.

Referring to FIGS. 8 and 9, a cross-sectional view of the air circuit breaker according to one embodiment of the present disclosure and an enlarged view of the portion A are illustrated. The main body 2 is located between the front base 4 and the rear base 3. An arc generated by the operation part 10 of the main body 2 is extinguished while passing though the arc extinguishing unit 20 on the operation part 10 and discharged. In this case, when a pressure of an arc gas reaches a predetermined pressure or more, the arc extinguishing unit 20 overcomes an elastic force of the spring 26a and slightly moves upward along a guide of the guide bolt 26, and some of the arc gas is discharged through the exhaust passage formed according to upward movement of the arc extinguishing unit 20 to adjust the pressure. However, when the pressure is lowered according to discharge of the arc gas, the arc extinguishing unit 20 moves downward to return to its original state. Normally, a state in which the head of the guide bolt 26 is in close contact with the through portion 28b due to the elastic force of the spring 26a is maintained to maintain a state in which the exhaust passage is closed.

Referring to FIGS. 10A and 10B, cross-sectional views of the arc gas discharge device of the air circuit breaker 1 according to one embodiment of the present disclosure before and after operating are illustrated. That is, in FIG. 10A, a state in which the exhaust passage is not opened, which is a normal state before operating, is illustrated, and in FIG. 10B, a state in which the exhaust passage is opened after operating is illustrated. That is, FIG. 10B is a view illustrating a case in which a pressure of an arc gas is a predetermined pressure or more and the arc extinguishing unit 20 slightly moves upward. Accordingly, the flange part 20b of the arc extinguishing unit 20 and cut portions 3b and 21a formed on the bases 3 and 4 overlap each other. In this case, the arc gas may pass through a space between the cut portions 3b and 21a and a horizontal and vertical gap between the flange part 20b and the seating groove 3c to be discharged. After the arc gas is discharged along the exhaust passage, when the pressure of the arc gas is lowered, the arc extinguishing unit 20 is slightly moved downward to its original position with respect to the bases 3 and 4 by an elastic force of the spring 26a to enter the state of FIG. 10A. Accordingly, the cut portions 3b and 21a are positioned at different levels, and the flange part 20b and the seating groove 3c are in close contact with each other to close the exhaust passage.

While some embodiments of the present disclosure have been described above, the spirit of the present disclosure is not limited to the embodiments proposed in this specification, and other embodiments may be easily suggested by adding, changing, and removing components within the scope of the disclosure by those skilled in the art and will fall within the spiritual range of the present disclosure.

The present disclosure can be applied to an air circuit breaker.

1. An arc gas discharge device of an air circuit breaker, comprising:
a base in which an arc extinguishing space, in which an arc generated by operation of a movable contact with respect to a stationary contact is extinguished, is formed;
an arc extinguishing unit which is installed in the arc extinguishing space of the base, includes a plurality of grids, extinguishes the arc, and discharges an arc gas upward;
a guide member which is installed on the base and guides the arc extinguishing unit while a portion of the arc extinguishing unit is restricted to slightly move the arc extinguishing unit upward or downward in the arc extinguishing space; and
an elastic member which provides an elastic force such that the arc extinguishing unit is in close contact with the base in the arc extinguishing space,
wherein, when a pressure of the arc gas is a predetermined pressure or more, the arc extinguishing unit overcomes the elastic force of the elastic member and moves upward, and
an exhaust passage is opened between the arc extinguishing unit and the base to discharge the arc gas.

2. The arc gas discharge device of claim 1, wherein the guide member is a guide bolt which passes through a through portion formed in the arc extinguishing unit and is fixed to the base.

3. The arc gas discharge device of claim 2, wherein:
a cross-shaped groove is formed in the base;
a nut is inserted into the cross-shaped groove not to be vertically come out; and
the guide bolt is fastened to the nut.

4. The arc gas discharge device of claim 3, comprising a cap which is inserted into the cross-shaped groove after the nut is inserted into the cross-shaped groove such that the nut is disposed at a fastening location.

5. The arc gas discharge device of claim 2, wherein the elastic member is a spring installed between a head of the guide bolt and the arc extinguishing unit.

6. The arc gas discharge device of claim 2, wherein the head of the guide bolt is formed to be greater than a diameter of a cross section of the elastic member.

7. The arc gas discharge device of claim 2, wherein the through portion of the arc extinguishing unit is formed in a cylindrical shape such that the elastic member is installed on an outer surface of the through bolt.

8. The arc gas discharge device of claim 1, wherein:
a seating groove is formed in the base such that a flange part of the arc extinguishing unit is seated in the seating groove;
cut surfaces are formed on an inner side of the seating groove and an inner side of the flange part; and
when the arc extinguishing unit moves upward, portions of the cut surfaces overlap to form an exhaust passage.

9. The arc gas discharge device of claim 8, wherein a vertical surface of the flange part and a vertical surface of the seating groove are spaced apart from each other and communicate with the exhaust passage.

10. The arc gas discharge device of claim 8, wherein:
the flange part and the seating groove are disposed in close contact with each other; and
the cut surfaces are formed by cutting a corner of a lower end portion of the flange part and a corner of an upper end portion of the seating groove in a chamfering manner.
